(19) United States
(12) Patent Application Publication
(10) Pub. No.: US 2018/0079916 A1
(43) Pub. Date: Mar. 22, 2018

(54) SPARKLING CLEAR COAT COMPOSITION

(71) Applicant: BOLLIG & KEMPER GMBH & CO. KG, Koeln (DE)

(72) Inventor: Jean-Francois ROLAND, Brie et Angonne (FR)

(73) Assignee: BOLLIG & KEMPER GMBH & CO. KG, Koeln (DE)

(21) Appl. No.: 15/563,722

(22) PCT Filed: Apr. 1, 2016
(86) PCT No.: PCT/EP2016/057281

§ 371 Date: Oct. 2, 2017

(30) Foreign Application Priority Data
Apr. 2, 2015 (EP) 15305492.9

(51) Int. Cl. C09D 5/36; C09D 7/12; C09D 7/00; B05D 7/00

(52) U.S. Cl. CPC C09D 5/36; C09D 7/1291; C08K 3/40; B05D 7/57; C09D 7/001

(57) ABSTRACT

The present invention relates to a liquid clear coating composition comprising a binder, a liquid carrier, and at least one effect pigment, wherein the liquid carrier is selected from the group comprising water, organic solvents or a mixture thereof, and wherein the effect pigment is a platelet glass flake pigment, characterized in that the glass flake pigment is comprised in the clear coating composition in a range between 0.001 weight-% and less than 0.80 weight %, based on the total weight of the clear coating composition, to a clear coat layer derived from the liquid composition, and to multilayer automotive coatings comprising the clear coat as well as to the method of producing the liquid clear coating composition.

The invention relates to the field of sparkling clear coat compositions and especially to the field of clear coat compositions for special effect automotive coatings.

Since many years there is a growing interest in the automotive field for coatings having a brilliant appearance and a high degree of luster and sparkle. In order to achieve coatings of such high quality appearance generally a wide variety of special effect pigments are used. Special effect pigments range from metal flake pigments like aluminum based pigments over mica and pearlescent pigments to glass flake pigments. However, in practice the pigments nearly always are included in the base coat layer of the multilayer automotive coating. In principle, the higher the amount of special effect pigment present in the base coat, the higher is the degree of sparkle achieved in the final coating. Like that, there is however a limit of the degree of sparkle and luster that can be achieved because the amount of pigment that can be included in the coating composition is generally limited at least by the factors of large scale industrial applicability and price.

It is also known from the patent literature that there is the possibility of including pigments in the clear coat of a multilayer coating for automotive applications. An example of incorporating glass flake pigments in a powder clear coating is described in U.S. Pat. No. 5,368,885 A. However, the pigmented clear coats have not found their way into being used in the industry which can be explained, for instance, by problems of their application to the car bodies with the standard application technics used in high volume production or in some other factors like a short shelf life or problems in their adhesion to the underlying base coat layers.

The object of the present invention therefore is to provide a clear coating composition that gives an outstanding degree of sparkle to a multilayer coating in the automotive filed and at the same time is suitable for being used in industry applications. Like that, the clear coat of the present invention should have a good shelf life, show a good adherence to the underlying base coat, and should be able to being applied with standard application methods and application gear.

The object is achieved by a liquid clear coating composition comprising a binder, a liquid carrier, and at least one effect pigment, wherein the liquid carrier is selected from the group comprising water, organic solvents or a mixture thereof, and wherein the effect pigment is a platelet glass flake pigment, characterized in that the glass flake pigment is comprised in the clear coating composition in a range between 0.001 weight-% and less than 0.80 weight-%, based on the total weight of the clear coating composition.

Surprisingly, it was found that very small amounts of a platelet glass flake pigment give an outstanding degree of sparkle and can achieve very attractive luster effects if they are included in a liquid clear coating composition. Like that, it is possible to achieve a novel optical effect in combining the generally underlying color base coating with the inventive clear coating. The relatively small amounts of glass flake pigments in the clear coating allow for the first time a bright and elegant sparkle where the brightness and specific tone of the underlying color can be easily changed by the amount and type of the platelet glass flake pigment, for instance by the specific coating of the platelet glass flake and its inherent own color. Moreover, it could be surprisingly shown in experiments that a glass flake pigment amount of under 0.80 weight-% based on the total weight of the composition resulted in a maximum total sparkle grade, whereas a higher amount of glass flake pigments did not add any sparkling grade at all. This findings were clearly unexpected because usually the higher the amount of effect pigment the more sparkle effect is resulted up to an amount were the pigments nearly “cover” the surface area.

Suitable glass flake pigments are favorably such that show a high degree of sparkle and luster. Such sparkle glass flake pigments usually comprise a flake or platelet shaped glass core and a coating of the core. The coating can be varied and/or tinted so that different color shades and brightness shades can be achieved. Such platelet glass flake pigments generally are known to a skilled person and are described, for instance, in WO 2008/122420 A1, in WO 2007/098897 A2, and in WO 2010/060590 A1, which are incorporated herein by reference.

In a preferred embodiment of the present invention the glass flake pigment has an aspect ratio in the range of 20 to 10,000, preferably in the range of 200 to 3,000, more preferably in the range of 300 to 1,500.

The improved aspect ratio derives from the fact that the glass platelets used in the clear coating composition of the invention have a very small thickness in relation to the size/diameter.

Like that, an improved parallel orientation to the substrate can be achieved which gives a better quality appearance and sparkle of the cured clear coat layer even when very low amounts of the platelet glass pigment are included in the coating.

In another preferred embodiment of the present invention the glass flake pigment has a particle size distribution (according to Malvern) d50 between 10 μm and 250 μm, preferably between 20 μm and 200 μm, most preferably between 25 μm and 150 μm. The size distribution is determined typically via laser granulometry.

Like that, the clear coating composition of the present invention can be applied in a layer thickness that is acceptable for applications in the automotive field. Generally, in the automotive field the interest is keeping the overall thickness of the multilayer coating including the clear coating as low as possible whilst at the same time meeting the high quality and durability requirements of the automotive industry.

In another preferred embodiment of the present invention the glass flake pigment comprises platelets of coated glass flakes, wherein the coating is selected from the group comprising titanium dioxide, tin oxide, iron oxide, silicon dioxide, copper, silver, gold, platinum, aluminum, alumina and mixtures thereof.

With this wide variety of coatings of the glass flakes and their inherently different shades there can be achieved very special effects in the resulting multilayer coating. Not only can a sparkling effect be added to the tone of the underlying base coat, but different highly desirable effects like brightening of the tone of the based coat layer and color mixing like, for example, adding a blue or golden sparkle to a black base coat can also accompany the sparkling effect. With the invention a new dimension of variability in terms of shade and appearance variety can be provided to the color and effect designer, especially for the field of OEM automotive industry coatings.

In another preferred embodiment of the present invention the clear coat composition does not contain any other effect pigments.

By the term “effect pigments” such pigments are understood that give optical effects other than color effects to the resulting coating, and which are—other than the most color imparting pigments—not soluble in the carrier medium. For further details, refer to Römpp Lexikon Lacke and Druckfarben, Georg Thieme Verlag, 1998, page 176, “Effect pigments” and pages 380 and 381 “Metal oxide/mica pigments”.

It is especially preferred in the clear coating composition according to the present invention that no further nonmetallic pigments, such as pearlescent pigments and interference pigments, and most especially no mica pigments, are used in combination to the platelet glass flake pigments.

Like that, the surprising and special effect of the low amount of glass flake pigments of less than 0.8 weight-% based on the total weight of the clear coating composition that can be measured in high sparkle intensity and even higher sparkle grade is especially pronounced.

The clear coatings can be used in automotive coatings as well as in industrial coatings. Especially preferred are automotive coatings. The clear coating composition of the present invention is a 1K clear coating composition or a 2K clear coating composition.

1K clear coating compositions are generally known to the skilled person. This is a term often used to describe a clear coating that does not require a hardener, catalyst or activator. For example, this term can be used to describe “single-component” or “single formulation” coating compositions.

2K clear coating compositions also are generally known to the skilled person. 2K is a term often used in the industry to describe a coating that needs to be mixed with a crosslinking, hardener, catalyst or activator component which is considered to stand for the second “K” for component. The mixing of the two components usually takes place shortly before the application of the coating to the substrate.

The binders may be curable physically, or thermally or thermally and with actinic radiation. The latter is referred to by those in the art as dual cure.

In the context of the present invention, the term “physical curing” denotes the curing of a layer of a coating material by film formation through loss of solvent from the coating material, with linking within the coating taking place via looping of the polymer molecules of the binders (regarding the term, cf. Römpp Lexikon, Lacke and Druckfarben, 1998, Georg Thieme Verlag, Stuttgart, Germany, pages 73 and 74, “Bindemittel”). Alternatively, filming takes place by way of the coalescence of binder particles (cf. Römpp, op. cit., pages 274 and 275, “Hartung”). Normally, no crosslinking agents are required for this purpose. If desired, the physical curing may be assisted by atmospheric oxygen, by heat, or by exposure to actinic radiation.

Where the binders are thermally curable, they may be thermally externally crosslinking or self-crosslinking, especially externally crosslinking. In the context of the present invention, the term self-crosslinking” refers to the property of a binder whereby it enters into crosslinking reactions with itself. A prerequisite for this is that the binders already include both kinds of complementary reactive functional groups that are necessary for thermal crosslinking, or reactive functional groups which are able to react “with themselves”. Externally crosslinking, on the other hand, is the term used to refer to those binders in which one kind of complementary reactive functional groups is present in the binder and the other kind in a curing or crosslinking agent. For further details, reference is made to Römpp, op. cit., “Hartung”, pages 274 to 276, especially page 275, bottom.

The binders of the coatings are oligomeric and polymeric resins. By oligomers are meant resins containing at least 2 to 15 monomer units in the molecule. In the context of the present invention, polymers are resins which contain at least 10 repeating monomer units in the molecule. For further details of these terms, reference is made to Römpp, op. cit., page 425, “Oligomere”. Examples of suitable binders are random, alternating and or block, linear and or branched and or comb addition (co)polymers of ethylenically unsaturated monomers, or polyaddition resins and or polycondensation resins. Regarding these terms, reference is made for further details to Römpp, op. cit., page 457, “Polyaddition” and “Polyadditionsharze (Polyaddukte)”, and also pages 463 and 464, “Polyckondensate”, “Polykondensation” and “Polykondensationsharze”, and also pages 73 and 74, “Bindemittel”.

Examples of suitable addition (co)polymers are (meth)acrylate (co)polymers or partially saponified polyvinyl esters, in particular (meth)acrylate copolymers, especially polyurethane modified (meth)acrylate copolymers.

Examples of suitable polyaddition resins and/or polycondensation resins are polyesters, alkyds, polyurethanes, polylactones, polycarbonates, polyethers, epoxy resins, epoxy resin-amine adducts, polyureas, polyamides, polyimides, polyester-polyurethanes, polyether-polyurethanes or polyester-polyether-polyurethanes, especially polyesters and polyurethanes.

Preferably, binders are used which contain carboxyl groups and preferably have an acid number of from 10 to 100 mg of KOH/g of binder and more preferably from 40 to 80 mg of KOH/g of binder. It is also preferred for these binders to have molecular weights of from 500 to about 5,000 g/mol.

In a preferred embodiment of the present invention the binder is selected from the group comprising polyacrylate, polyurethane, polycarbonate, polyester, nitrocellulose, alkyd, aminoplast, polyepoxide, polyvinyl, polyisocyanate, and mixtures and/or copolymers thereof.

The coating compositions of the present invention further contain water and/or organic solvent(s) as liquid carriers. The organic solvent(s) are either miscible with water or immiscible with water.

In the context of the present invention, water miscible organic solvents are typical paint solvents which are miscible in any proportion with water, such as ethylene glycol, propylene glycol, butyl glycol and the methyl, ethyl or propyl ethers thereof, ketones such as acetone or diacetone alcohol, cyclic ethers such as tetrahydrofuran or dioxane, or amides such as N.N-dimethylformamide or N-methylpyrrolidone (cf. Paints Coatings and Solvents, edited by Dieter Stoye and Werner Freitag, second edition, Wiley-VCH, Weinheim and New York, 1998, pages 329 and 330).

The organic solvents which are immiscible with water or sparingly miscible with water accommodate preferably less than 10, more preferably less than 9, and in particular less than 8% by weight of water at 20° C., based on water and solvent. Conversely, water accommodates preferably less than 6, more preferably less than 5, and in particular less than 4% by weight, at 20° C., based on water and solvent. Examples of suitable organic solvents immiscible with water or sparingly miscible with water are ketones such as methyl isobutyl ketone, diisobutyl ketone, cyclohexanone or trimethylcyclohexanone, ethers as dibutyl ether, esters such as isopropyl acetate, butyl acetate, ethyl glycol acetate or butyl glycol acetate, or higher alcohols such as hexanol, cyclohexanol, trimethylcyclohexanol or 2-ethyl-1-hexanol (isooctanol) (cf. Paints Coatings and Solvents, edited by Dieter Stoye and Werner Freitag, second edition, Wiley-VCH, Weinheim and New York, 1998, pages 329 and 330).

It is especially preferred that the liquid carrier is selected from the group comprising water, ketones, aliphatic and/or aromatic hydrocarbons, glycol ethers, alcohols, esters, and mixtures thereof.

The coating material of the invention may additionally comprise additives such as nanoparticles or reactive diluents which are curable thermally or with actinic radiation. In the context of the present invention, actinic is electromagnetic radiation, such as near infrared, visible light, UV radiation or X-rays, especially UV and corpuscular radiation such as electron beams. Furthermore the inventive coating composition may contain further additives such as for example UV absorbers like HALS substances, light stabilizers, free-radical scavengers, thermolabile free-radical initiators, photoinitiators and photocoinitiators, crosslinking agents, thermal crosslinking catalysts, devolatilizers, slip additives, polymerization inhibitors, defoamers, emulsifiers, wetting agents, dispersants, adhesion promoters, leveling agents, film forming auxiliaries, rheology control additives (thickeners), flame retardants, siccatives, dryers, antiskinning agents, corrosion inhibitors, waxes and or flatting agents.

Advantageously, the glass flake pigment is comprised in the clear coating composition in a range between 0.003 weight-% and less than 0.70 weight-%, based on the total weight of the clear coating composition, more preferably the glass flake pigment is comprised in the clear coating composition in a range between 0.02 weight-% and 0.60 weight-%, based on the total weight of the clear coating composition, and especially in a range between 0.10 weight-% and 0.40 weight-%, based on the total weight of the clear coating composition.

In another aspect of the present invention the invention relates to an automotive coating comprising a clear coat layer made of a clear coating composition like described above, and preferably to an automotive coating where the coating comprises a primer layer which is applied on top of an electrophoretic anti-corrosion layer, a base coat layer and the clear coat layer made of a clear coating as described above. Alternatively, the automotive coating comprises a first base coat layer, a second base coat layer applied on top of the first base coat layer, and the clear coat layer as described above according to the invention. According to another alternative, the multilayer coating can comprise a first base coat layer, a second base coat layer and a third base coat layer, both applied on top of the first base coat one after the other, and a clear coat layer made of a sparkling clear coat composition of the present invention.

The selection of electrophoretic anti-corrosion coating, primer, and base coat used in the multilayer coating for automotive coatings comprising a sparkling clear coat according to this invention is not limited but can rather be made from all known coating systems. For example, the primer can be solvent based or waterborne as can the base coating be. The use of waterborne base coats is however preferred.

In another aspect of the present invention the invention relates to a method for producing a clear coating composition according to the invention as described above comprising the steps of
a) providing a dispersion or a solution of a binder in a liquid carrier,
b) adding at least a platelet glass flake pigment to the dispersion or solution, and
c) stirring the resultant mixture for at least 1 minute.

It could be shown that the incorporation of the platelet glass flake pigments in the clear coating composition does not require special steps but can be carried out simply by addition of the pigment powder to the dispersion or solution of the other components of the composition like binder and additives in water or a suitable solvent, but preferably in water. Alternatively, the glass flake pigment powder can first be mixed with the solvent or water and the dispersion of the pigment is added to the liquid mixture of the other components like binders and additives.

The invention is further illustrated by the following examples, however, without limiting the scope of invention.

### EXAMPLES

### Examples A

A test panel of galvanized rolled steel was coated with a cathodic electrodeposition coat, a primer coat, a base coat of grey shade, and a 2K clear coat. The total film thickness of the multilayer coating was 85 μm.

A1: According to the invention the 2K clear coat layer was prepared from a commercially available 2K clear coat composition by addition of a platelet glass flake pigment, like for example pigments from the Luxan® series of Eckart or like metashine 2025PSTM from Toyo Aluminium, in amounts starting from 0.001 weight-% and ranging up to 3.0 weight-%, based on the total weight of the liquid clear coat composition, mixing, robot application, and subsequent hardening.

A2: In a comparative example the same multilayer system as in A1 was applied to a test panel, but the glass flake pigments were included in the base coat composition by mixing and the base coat composition carrying the platelet glass flake pigment was subsequently coated with the 2K clear coat composition without any pigments.

### Example B

A test panel of galvanized rolled steel was coated with a cathodic electrodeposition coat, a first base coat, a second base coat of grey shade, and a 2K clear coat. The first base coat had a thickness of 16 μm and the second base coat had a thickness of 7 μm. The second base coat composition had a pH of 8.1, a viscosity of 162 mPa·s, and solid content of 23.4 weight-%, based on the total weight of the base coat composition. The total film thickness of the resultant multilayer coating was 95 μm.

B1: According to the invention the 2K clear coat layer was prepared from a commercially available 2K clear coat composition by addition of a platelet glass flake pigment, like for example pigments from the Luxan® series of Eckart or like metashine 2025PSTM from Toyo Aluminium, in amounts starting from 0.001 weight-% and ranging up to 3.0 weight-%, based on the total weight of the liquid clear coat composition, mixing, robot application, and subsequent hardening.

B2: In a comparative example the same multilayer system as in B1 was applied to a test panel, but the glass flake pigments were included in the second base coat composition by mixing and the second base coat composition carrying the platelet glass flake pigment was subsequently coated with the 2K clear coat composition without any pigments.

### Example C

A test panel of galvanized rolled steel was coated with a cathodic electrodeposition coat, a first base coat, a second base coat of grey shade, a third base coat of grey shade, and a 2K clear coat. The first base coat had a thickness of 15 μm and the second base coat had a thickness of 8 μm and the third base coat had a thickness of 4 μm. The base coat composition used in the second and third layers had a pH of 8.1, a viscosity of 150 mPa·s, and a solid content of 21 weight-%, based on the total weight of the base coat composition. The total film thickness of the resultant multilayer coating was 80 μm.

C1: According to the invention the 2K clear coat layer was prepared from a commercially available 2K clear coat composition by addition of a platelet glass flake pigment, like for example pigments from the Luxan® series of Eckart or like metashine 2025PSTM from Toyo Aluminium, in amounts starting from 0.001 weight-% and ranging up to 3.0 weight-%, based on the total weight of the liquid clear coat composition, mixing, robot application, and subsequent hardening.

C2: In a comparative example the same multilayer system as in B1 was applied to a test panel, but the glass flake pigments were included in the second base coat composition by mixing and the second base coat composition carrying the platelet glass flake pigment was subsequently coated with the 2K clear coat composition without any pigments.

As a 2K clear coat composition in all examples A to C a composition with the following specifics was used:

Clear coat composition

| Raw materials | Weight (g) | Supplier |
|---|---|---|
| Setalux 1767 VV-65 (acrylic polyol) | 31.1 | Nuplex |
| Setalux 91767 VX-60 (acrylic polyol) | 29.8 | Nuplex |
| TinStab BL 277 (1% in butyl acetate) | 0.6 | Akcros |
| (dibutyltin dilaurate) | | chemical |
| Baysilon OL-17 (2% in butyl acetate) | 1.8 | OMG Borchers |
| (polyether-modified methylpolysiloxan) | | |
| Byk 306 (silicone-containing surface | 0.3 | Byk chemie |
| additive) | | GmbH |
| Tinuvin 1130 (UV absorber) | 0.9 | BASF |
| Tinuvin 292 (HALS) | 0.6 | BASF |
| Solvesso 100 (solvent naphtha) | 3.3 | Exxon Mobil |
| Hardener *) | 31.6 | |
| Total | 100 | |
| Desmodur N 3390 (aliphatic polyisocyanate) | 53 | Bayer |
| Vestanat T 1890 E (cycloaliphatic | 28.9 | Evonik |
| polyisocyanate) | | |
| Dowanol PM acetate | 18.1 | Dow chemicals |
| Total | 100 | |

*) Hardener composition

Sparkling Test

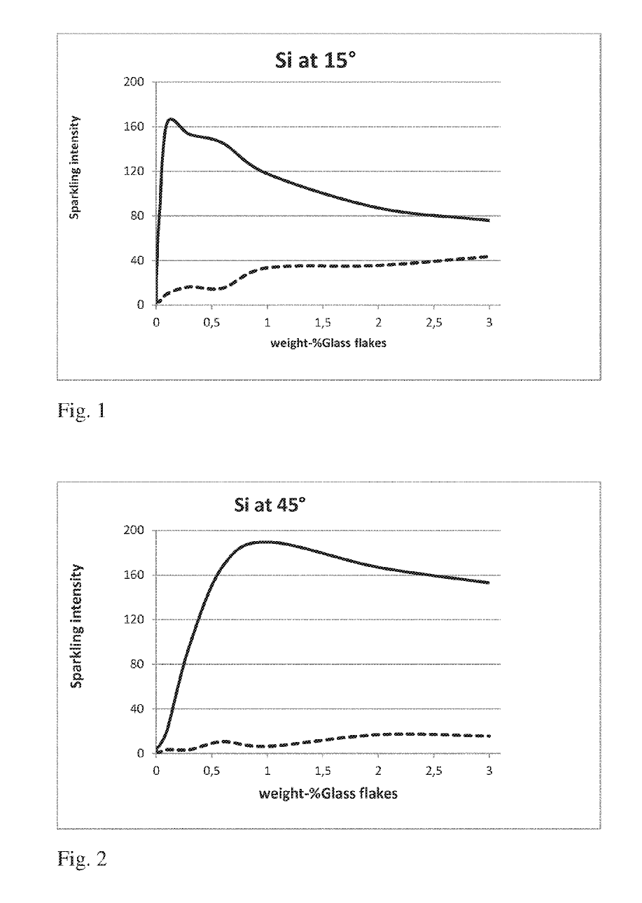

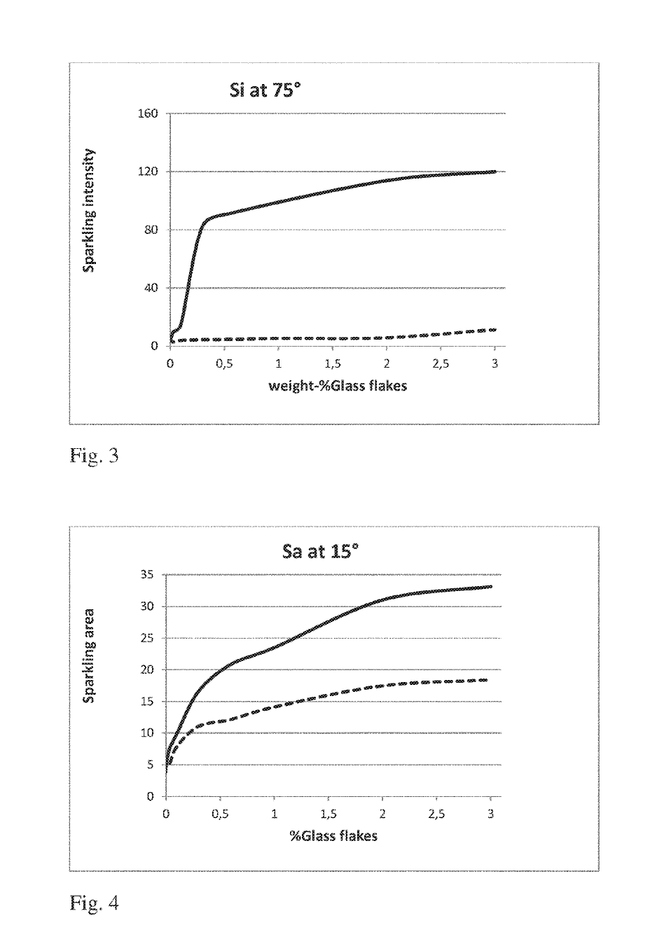

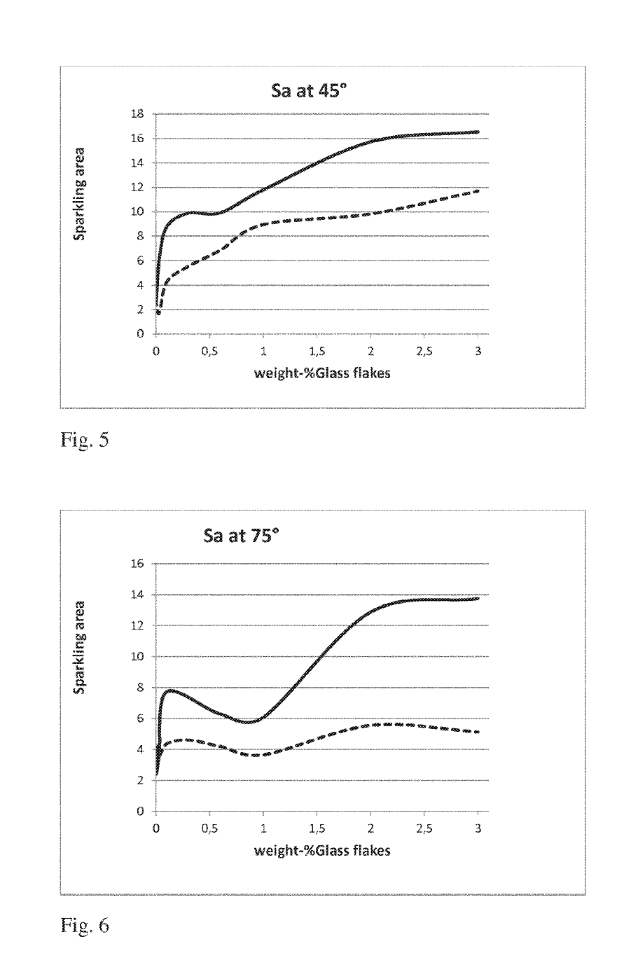

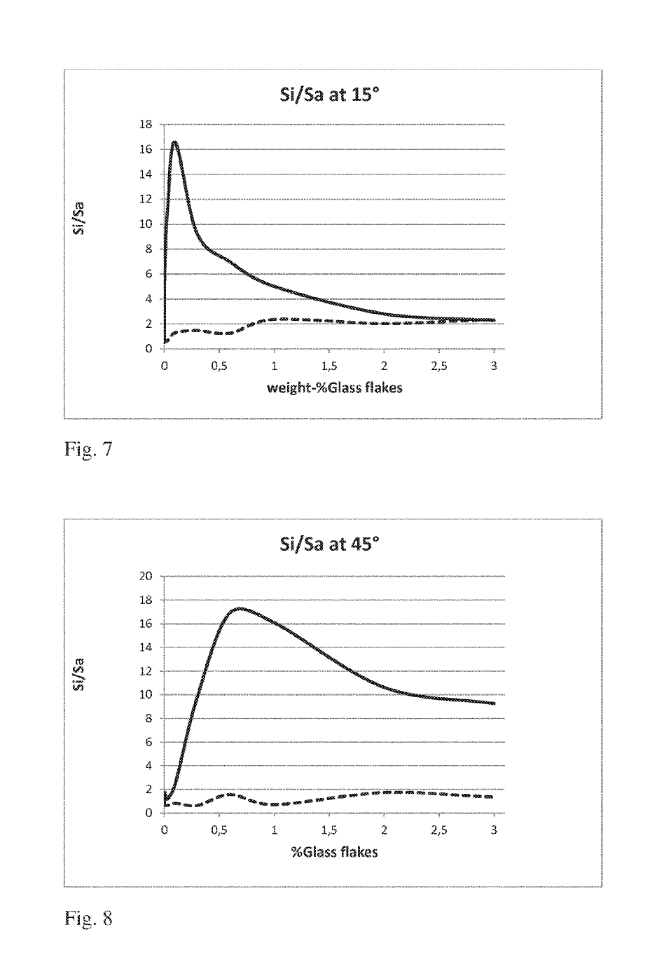

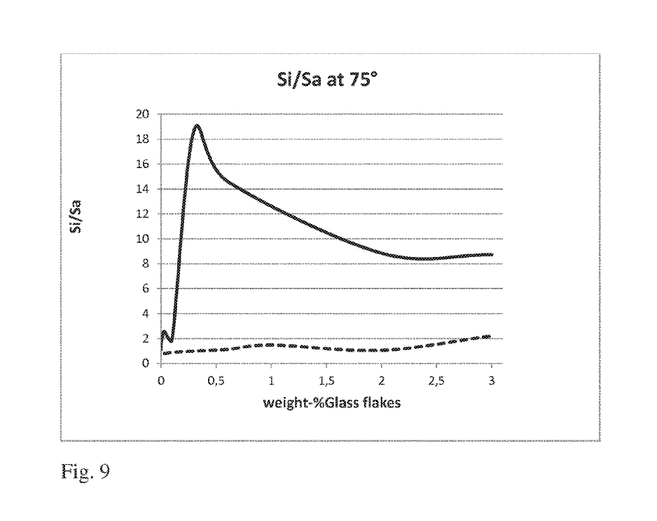

For the example B a sparkling test was carried out to determine the sparkling intensity (Si) and sparkling area (Sa) in three different angles, i.e. at 15°, at 45° and at 75° with a Byk-mac testing device of BYK-Gardner GmbH which is based on camera analysis. Sparkling intensity (Si) is a measure of how strong is the light flash of the effect pigment. A total sparkle grade (Si/Sa) is then determined as a function of sparkle intensity and sparkle area. The results of the sparkling test are shown in the FIGS. 1 to 9.

TABLE 1
Measures of the sparkling in function of the glass flakes when included in the clear
coat = B1

| | Si | | | Sa | | | Si/Sa | | |
|---|---|---|---|---|---|---|---|---|---|
| x % glass flakes | 15° | 45° | 75° | 15° | 45° | 75° | 15° | 45° | 75° |
| 0 | 2 | 2.25 | 5.41 | 3.95 | 2.86 | 3.44 | 0.51 | 0.79 | 1.57 |
| 0.003 | 28.27 | 4.84 | 4.18 | 4.9 | 2.78 | 2.42 | 5.77 | 1.74 | 1.73 |
| 0.030 | 83.26 | 7.17 | 9.75 | 7.42 | 6.09 | 3.78 | 11.22 | 1.18 | 2.58 |
| 0.10 | 163.57 | 21.16 | 14.61 | 9.87 | 8.76 | 7.72 | 16.57 | 2.42 | 1.89 |
| 0.30 | 153.17 | 96.21 | 82.45 | 16.58 | 9.88 | 4.41 | 9.24 | 9.74 | 18.70 |
| 0.60 | 145.34 | 167.71 | 92.04 | 20.85 | 9.91 | 6.29 | 6.97 | 16.92 | 14.63 |
| 1 | 117.79 | 189.7 | 26 | 23.5 | 11.79 | 6.07 | 5.01 | 16.09 | 4.28 |
| 2 | 87.13 | 166.98 | 113.85 | 31.02 | 15.72 | 12.87 | 2.81 | 10.62 | 8.85 |
| 3 | 75.88 | 152.99 | 119.94 | 33.14 | 16.53 | 13.74 | 2.29 | 9.26 | 8.73 |

x = weight-% of total clear coat composition

TABLE 2
Measures of the sparkling in function of the glass
flakes when included in the base coat = B2

| x % | | | | | | | | | |
|---|---|---|---|---|---|---|---|---|---|
| glass | Si | | | Sa | | | Si/Sa | | |
| flakes | 15° | 45° | 75° | 15° | 45° | 75° | 15° | 45° | 75° |
| 0 | 2 | 2.25 | 5.41 | 3.95 | 2.86 | 3.44 | 0.51 | 0.79 | 1.57 |
| 0.003 | 3.08 | 1.63 | 4.12 | 4.96 | 2.46 | 4.22 | 0.62 | 0.66 | 0.98 |
| 0.030 | 3.32 | 1.12 | 2.87 | 4.97 | 1.73 | 3.6 | 0.67 | 0.65 | 0.80 |
| 0.100 | 10.12 | 3.55 | 3.88 | 7.86 | 4.25 | 4.36 | 1.29 | 0.84 | 0.89 |
| 0.30 | 16.31 | 3.5 | 4.52 | 11.06 | 5.52 | 4.61 | 1.47 | 0.63 | 0.98 |
| 0.60 | 15.27 | 10.73 | 4.7 | 12.16 | 6.86 | 4.19 | 1.26 | 1.56 | 1.12 |
| 1 | 33.47 | 6.45 | 5.37 | 14.13 | 8.96 | 3.65 | 2.37 | 0.72 | 1.47 |
| 2 | 35.56 | 16.91 | 5.81 | 17.47 | 9.82 | 5.55 | 2.04 | 1.72 | 1.05 |
| 3 | 43.58 | 15.76 | 11.31 | 18.41 | 11.69 | 5.13 | 2.37 | 1.35 | 2.20 |

x = weight-% of total clear coat composition

For each angle it was found that sparkling intensity (Si), sparkling area (Sa), and total sparkle grade (Si/Sa) are higher for the single measurements of the example B1 multilayer coating system. The total sparkle grade Si/Sa of the examples of the B1 system presents a maximum between 0.003% weight-% and 0.8 weight-% of platelet glass flake pigments, based on the total weight of the clear coating composition, comprised in the applied liquid clear coating composition.

However, whatever is the typical automotive multilayer coating system A, B, or C, the results are identical: The sparkling effect is much more prominent when the glass flakes are included in the clear coat than it is when they are included in the base coat, and the glass flakes amount needed is also much lower, even surprisingly low.

Optical Evaluation, Change in Shade

When added in the clear coat of example A1 and B1 the platelet glass flakes bring a strong effect starting as low as 0.003 weight-% of concentration in the liquid composition, with a shade becoming even lighter with the increase of concentration.

In contrast, when added in the base coat layer of example A2, the glass flakes do not bring about a strong effect, no lightening is observed.

When added in the second base coat layer of example B2 or the third base coat layer in example C2 the effect is much less strong. Only in a high concentration of the glass flakes in the second base coating composition of 3.0 weight-%, based on the total weight of the composition, a comparable shade as in the example B1 and C1 at the same concentration of 3.0 weight-% could be achieved.

Optical Evaluation, Change in Appearance and Tense

It was found that appearance of the test panels with multilayer coatings the examples A1, B1, and C1 stayed good for concentrations of the glass flakes up to 1.0 weight-%. Higher concentrations of the glass pigments in both systems lead to a loss in quality of appearance. It was also found that the final tense was better for the optical evaluation test of examples A1, B1 and C1 compared to that of the examples A2, B2, and C2.

1. A liquid clear coating composition comprising a binder, a liquid carrier, and at least one effect pigment, wherein the liquid carrier is selected from the group comprising water, organic solvents or a mixture thereof, and wherein the effect pigment is a platelet glass flake pigment, wherein the glass flake pigment is comprised in the clear coating composition in a range between 0.001 weight-% and less than 0.80 weight-%, based on the total weight of the clear coating composition.

2. The composition according to claim 1, wherein the glass flake pigment is comprised in the clear coating composition in a range between 0.003 weight-% and less than 0.70 weight-%, based on the total weight of the clear coating composition.

3. The composition according to claim 1, wherein the glass flake pigment is comprised in the clear coating composition in a range between 0.02 weight-% and 0.60 weight-%, based on the total weight of the clear coating composition.

4. The composition according to claim 1, wherein the glass flake pigment is comprised in the clear coating composition in a range between 0.10 weight % and 0.40 weight-%, based on the total weight of the clear coating composition.

5. The composition according to claim 1, wherein the glass flake pigment has an aspect ratio in the range of 20 to 10,000.

6. The composition according to claim 1, wherein the glass flake pigment has a particle size distribution according to Malvern d50 between 10 μm and 250 μm.

7. The composition according to claim 1, wherein the glass flake pigment comprises platelets of coated glass flakes, wherein the coating is selected from the group comprising titanium dioxide, tin oxide, iron oxide, silicon dioxide, copper, silver, gold, platinum, aluminum, alumina and mixtures thereof.

8. The composition according to claim 1, wherein the clear coating composition is a 1K clear coating composition or a 2K clear coating composition.

9. The composition according to claim 1, wherein the binder is selected from the group comprising polyacrylate, polyurethane, polycarbonate, polyester, nitrocellulose, alkyd, aminoplast, polyepoxide, polyvinyl, polyisocyanate, and mixtures and/or copolymers thereof.

10. The composition according to claim 1, wherein the liquid carrier is selected from the group comprising water, ketones, aliphatic and/or aromatic hydrocarbons, glycol ethers, alcohols, esters, and mixtures thereof.

11. An automotive coating comprising a clear coat layer made of a clear coating composition according to claim 1.

12. The automotive coating according to claim 11 wherein the coating comprises a primer layer, a base coat layer and said clear coat layer.

13. The automotive coating according to claim 11 wherein the coating comprises a first base coat layer, a second base coat layer applied on top of the first base coat layer, and said clear coat layer.

14. The automotive coating according to claim 11 wherein the coating comprises a first base coat layer, a second base coat layer applied on top of the first base coat layer, a third base coat layer applied on top of the second base coat layer, and said clear coat layer.

15. A method for producing a clear coating composition according to claim 1, comprising the steps of
a) providing a dispersion or a solution of a binder in a liquid carrier,
b) adding at least a platelet glass flake pigment to the dispersion or solution, and
c) stirring the resultant mixture for at least 1 minute.

16. The composition according to claim 1, wherein the glass flake pigment has an aspect ratio in the range of 200 to 3,000.

17. The composition according to claim 1, wherein the glass flake pigment has an aspect ratio in the range of 300 to 1,500.

18. The composition according to claim 1, wherein the glass flake pigment has a particle size distribution according to Malvern d50 between 20 μm and 200 μm.

19. The composition according to claim 1, wherein the glass flake pigment has a particle size distribution according to Malvern d50 between 25 μm and 150 μm.
